(19) United States
(12) Patent Application Publication
(10) Pub. No.: US 2025/0391855 A1
(43) Pub. Date: Dec. 25, 2025

(54) POSITIVE ELECTRODE ACTIVE MATERIAL, POSITIVE ELECTRODE PLATE, AND NON-AQUEOUS ELECTROLYTE SECONDARY BATTERY

(71) Applicant: Prime Planet Energy & Solutions, Inc., Tokyo (JP)

(72) Inventors: Ryo HANAZAKI, Kobe-shi (JP); Shoji NONAKA, Takasago-shi (JP); Junichi SUGIYAMA, Kobe-shi (JP)

(21) Appl. No.: 19/235,575

(22) Filed: Jun. 12, 2025

(30) Foreign Application Priority Data
Jun. 19, 2024 (JP) 2024-098717

(51) Int. Cl. H01M 4/525; C01G 53/506; H01M 4/36

(52) U.S. Cl. CPC H01M 4/525; C01G 53/506; H01M 4/366; C01P 2002/54; C01P 2002/60; C01P 2002/74; C01P 2004/50; C01P 2004/61; C01P 2004/62; C01P 2006/12; C01P 2006/40

(57) ABSTRACT

Provided is a positive electrode active material that makes it possible to obtain a non-aqueous electrolyte secondary battery with excellent input-output properties and excellent capacity retention during charge-discharge cycles.

[Solution] A positive electrode active material comprising a first particle group and a second particle group, wherein the first particle group contains a plurality of first particles, the second particle group contains a plurality of second particles, the first particles include particles each having a gap portion, the second particles include secondary particles each consisting of primary particles aggregated together, an integrated intensity ratio (I₀₀₃/I₁₀₄) of diffraction peaks of the secondary particle obtained by an X-ray diffraction method is from 1.05 to 1.19, and the secondary particle has a crystallite size L₀₀₃ of 1000 Å or more.

### CROSS REFERENCE TO RELATED APPLICATIONS

This nonprovisional application is based on Japanese Patent Application No. 2024-098717 filed on Jun. 19, 2024, with the Japan Patent Office, the entire contents of which are hereby incorporated by reference.

### BACKGROUND OF THE INVENTION

### Field of the Invention

The present disclosure relates to a positive electrode active material, and it also relates to a positive electrode plate and a non-aqueous electrolyte secondary battery. Description of the Background Art

Japanese Patent Laying-Open No. 2013-93295 discloses a positive electrode composite material containing at least two types of positive electrode active material particles that are different in average particle size.

Japanese Patent Laying-Open No. 2020-87879 discloses lithium-metal composite oxide powder composed of secondary particles each of which consists of primary particles aggregated together as well as single particles that are present independently of the secondary particles.

### SUMMARY OF THE INVENTION

An object of the present disclosure is to provide a positive electrode active material that makes it possible to obtain a non-aqueous electrolyte secondary battery with excellent input-output properties and excellent capacity retention during charge-discharge cycles (hereinafter also called cycle capacity retention).
[1] A positive electrode active material comprising:
a first particle group; and
a second particle group, wherein
the first particle group contains a plurality of first particles,
the second particle group contains a plurality of second particles,
the first particles include particles each having a gap portion,
the second particles include secondary particles each consisting of primary particles aggregated together,
an integrated intensity ratio (I₀₀₃/I₁₀₄) of diffraction peaks of the secondary particle obtained by an X-ray diffraction method is from 1.05 to 1.19, and
the secondary particle has a crystallite size L₀₀₃ of 1000 Å or more.
[2] The positive electrode active material according to [1], wherein a mass ratio between the first particle group and the second particle group in the positive electrode active material is (First particle group): (Second particle group) =8:2 to 5:5.
[3] The positive electrode active material according to [1] or [2], wherein the first particle has a circularity of 0.92 or more.
[4] The positive electrode active material according to any one of [1] to [3], wherein the first particle has a core portion, the gap portion outside the core portion, and an outer portion outside the gap portion.
[5] The positive electrode active material according to any one of [1] to [4], wherein the first particle group has an average particle size of 8 to 20 μm.
[6] The positive electrode active material according to any one of [1] to [5], wherein the second particle group has an average particle size of 2 to 7 μm.

[7] The positive electrode active material according to any one of [1] to [6], wherein
the second particle contains a lithium-(transition metal) composite oxide having a layered crystal structure, and
the lithium-(transition metal) composite oxide contains Li, Ni, Mn, Co, and M, where
   M is one or more metallic elements selected from the group consisting of Mg, Ca, Al, Ti, V, Cr, Fe, Cu, Zn, Zr, Nb, Mo, Ta, and W,
   a molar ratio between Li, Ni, Mn, Co, and M is Li:Ni:Mn:Co:M=a:x:y:z:t, and
   a, x, y, z, and t satisfy 1.0≤a≤1.3, x+y+z=1, 0.25≤x≤0.9, 0<y≤0.6, 0<z≤0.6, and 0<t≤0.1.
[8] A positive electrode plate comprising the positive electrode active material according to any one of [1] to [7].
[9] A non-aqueous electrolyte secondary battery comprising the positive electrode plate according to [7].

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross-sectional view of a particle having a gap portion.

FIG. 2 is a schematic cross-sectional view for explaining a reaction tank in which a Taylor vortex reaction field is to be generated.

FIG. 3 is a schematic cross-sectional view of a positive electrode plate in a thickness direction.

### DESCRIPTION OF THE PREFERRED EMBODIMENTS

### Positive Electrode Active Material

A positive electrode active material according to the present disclosure comprises a first particle group and a second particle group. The first particle group contains a plurality of first particles. The second particle group contains a plurality of second particles. The first particles include particles each having a gap portion. The second particles include secondary particles each consisting of primary particles aggregated together. An integrated intensity ratio (I₀₀₃/I₁₀₄) of diffraction peaks of the secondary particle obtained by an X-ray diffraction method (hereinafter, this ratio is also simply called an integrated intensity ratio) is from 1.05 to 1.19. The secondary particle has a crystallite size L₀₀₃ (hereinafter also called a crystallite size) of 1000 Å or more.

In a positive electrode active material layer composed of positive electrode active material particles including two types of particles that are different in average particle size, lithium-ion diffusion distance inside a particle with relatively large average particle size is relatively long, which tends to degrade input-output properties. On the other hand, in a positive electrode active material layer composed of positive electrode active material particles including single particles as well as aggregated particles that are secondary particles each consisting of a plurality of primary particles aggregated together, lithium ion diffusivity inside the single particles is relatively low as compared to the aggregated particles and, thereby, lithium-ion diffusion distance inside the single particles is relatively long, which tends to degrade input-output properties; in addition to this, single particles tend to be relatively costly to produce. Moreover, when crystal growth of the primary particles of the aggregated particles is facilitated too much, the particles tend to break in the rolling step of the production of the positive electrode active material layer, which tends to degrade cycle capacity retention. With the use of the positive electrode active material according to the present disclosure, since it comprises first particles and second particles, it is possible to obtain a non-aqueous electrolyte secondary battery (hereinafter also called a battery) with excellent input-output properties and excellent cycle capacity retention. Each of the input-output properties and the cycle capacity retention is evaluated by a method that is described below in the Examples section.

The first particle group contains a plurality of first particles. The content of the first particles in the first particle group, relative to the total amount of the first particle group which is regarded as 100 mass %, is from 70 to 100 mass %, for example, and it may be from 85 to 98 mass %, or may be from 90 to 95 mass %. It is possible that the first particle group solely contains a plurality of first particles.

The average particle size of the first particle group may be from 2 to 20 um, for example, and it is preferably from 8 to 20 μm. Herein, the average particle size refers to the particle size (D50) in volume-based particle size distribution at which cumulative frequency of particle sizes accumulated from the small size side reaches 50%. The volume-based particle size distribution can be measured with a laser-diffraction particle size distribution analyzer. The average particle size of the first particle group can be controlled by, for example, regulating the raw material composition and calcination conditions (such as the calcination temperature and the calcination duration) and selecting the type and the particle size of precursor particles that are used for producing the first particles.

The first particles include particles each having a gap portion. It is possible that the first particles include only such particles each having a gap portion. A description will be given of the particle having a gap portion, referring to FIG. 1. FIG. 1 is a schematic cross-sectional view of a particle 10 having a gap portion. Particle 10 having a gap portion has a core portion 11, a gap portion 12, and an outer portion 13. Particle 10 having a gap portion may be a secondary particle consisting of primary particles aggregated together (hereinafter also called a first secondary particle). The first secondary particles are different from the below-described second secondary particles, which are included in the second particles. Particle 10 having a gap portion has one core portion and one layer of an outer portion. Having the gap portion, particle 10 having a gap portion tend to have an enhanced Li diffusivity inside the particle and thereby tends to provide excellent input-output properties.

Gap portion 12 can be the space between core portion 11 and outer portion 13. Core portion 11 may be made of primary particles 14 aggregated together. Core portion 11 may have a solid structure, or may have a hollow structure. When core portion 11 has a hollow structure, the hollow of core portion 11 is not regarded as gap portion 12. Outer portion 13 may be made of primary particles 15 aggregated together. Core portion 11 and outer portion 13 may be completely separated from each other by gap portion 12, or alternatively, at a part of particle 10 having a gap portion, primary particles 14 and primary particles 15 may be in contact with each other and thereby core portion 11 and outer portion 13 may be in contact with each other. FIG. 1 illustrates only some of primary particles 14 and primary particles 15.

Particle 10 having a gap portion may further have one or more layers of additional outer portion outside the outer portion 13. When particle 10 having a gap portion has two or more layers of outer portions, particle 10 having a gap portion may have two layers of gap portions. Outer portion 13 may be formed in such a manner to either completely or partly cover the core portion 11.

The circularity of particle 10 having a gap portion may be 0.92 or more, for example, and it is preferably 0.93 or more, more preferably 0.94 or more; and it may be 1.00 or less, for example. The circularity of particle 10 having a gap portion is the average of fifty particles 10 each having a gap portion. When the circularity of particle 10 having a gap portion is 0.92 or more, packing properties tend to be enhanced. Herein, the circularity is calculated by the following equation.

$$Circularity = ( Perimeter of a circle the area of which is equal to the projected area of the particle ) / ( Perimeter of the particle )$$

The circularity of the particle having a gap portion is the average of fifty particles each having a gap portion.

The average ratio (%) of the width (thickness) of gap portion 12 to the particle size (diameter) of particle 10 having a gap portion (hereinafter also called a first ratio) may be 10% or more or 40% or more, and it may be 80% or less or 70% or less, for example. The particle size of particle 10 having a gap portion can be the diameter of a hypothetical circle when particle 10 having a gap portion in a cross section of particle 10 having a gap portion is regarded as a circle. For example, in FIG. 1, the particle size of particle 10 having a gap portion is shown as a straight line 16. The width (thickness) of gap portion 12 can be a part of the above-mentioned diameter (straight line 16) of particle 10 having a gap portion overlapping the gap portion 12.

The average ratio (%) of the thickness of outer portion 13 to the particle size (diameter) of particle 10 having a gap portion (hereinafter also called a second ratio) can be from 3% to 50%. The thickness of outer portion 13 can be a part of the above-mentioned diameter (straight line 16) of particle 10 having a gap portion overlapping the outer portion 13. Each of the first ratio and the second ratio is the average of fifty particles 10 each having a gap portion. The first ratio and the second ratio are measured by a method described below in the Examples section.

The ratio of gap portion 12 to the total volume of particle 10 having a gap portion may be 10% or more or 40% or more or 60% or more, and may be 30% or less or 60% or less or 80% or less, for example. Herein, the ratio of gap portion 12 to the total volume of particle 10 having a gap portion is determined by performing image processing of a cross-sectional SEM image of particle 10 having a gap portion, discriminating gap portion 12 from the portion where primary particles 14 and 15 are present, and calculating the ratio of the total area of gap portion 12 to the area of particle 10 having a gap portion.

The BET specific surface area of particle 10 having a gap portion may be from 0.5 to 2.8 m²/g, for example. The BET specific surface area is measured by a method described below in the Examples section.

The primary particle size of particle 10 having a gap portion may be from 0.1 to 1.0 μm, for example. The primary particle size of particle 10 having a gap portion is measured by a method described below in the Examples section.

Particle 10 having a gap portion has a relatively uniform gap portion in a cross section, and therefore when used in a positive electrode plate, the output properties and the capacity properties of the battery tend to be enhanced.

Particle 10 having a gap portion may be a particle made of a composite oxide containing Li and Ni, and may be a particle made of a transition metal composite oxide containing Li, Ni, and Mn, and may be a particle made of a transition metal composite oxide containing Li, Ni, Co, and Mn.

For example, particle 10 having a gap portion may be a particle made of a transition metal composite oxide (hereinafter also called a first composite oxide) having a layered crystal structure represented by a formula (i) below:

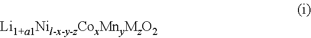

[in the formula (i),
−0.1≤a1<0.3, 0≤x<0.5, 0≤y<0.5, 0≤z<0.05, and
M is one or more elements selected from the group consisting of Al, Ti, Zr, B, Mg, Fe, Cu, Zn, Sn, Na, K, Ba, Sr, Ca, W, Mo, Nb, Si, V, Cr, and Ge].

The composition of the first composite oxide can be regulated by changing the amount (the blending ratio) of lithium to be added, the type of the raw material, and the amount of the raw material to be used for producing the first composite oxide. The composition of the first composite oxide can be determined by high-frequency inductively coupled plasma (ICP) atomic emission spectrometry (ICP-AES). More specifically, it can be measured in accordance with JIS K 0116:2014 “General rules for atomic emission spectrometry”; for example, the first composite oxide is dissolved by an alkali fusion method and diluted with ultrapure water, tartaric acid, or hydrochloric acid to make a certain amount in total to be subjected to analysis on a high-resolution ICP emission spectrochemical analyzer (“PS3500DDII” manufactured by Hitachi High-Tech Science). The wavelengths for respective elements in ICP-AES measurement can be set as 670.784 nm for Li, 238.892 nm for Co, 257.61 nm for Mn, and 231.604 nm for Ni.

Particle 10 having a gap portion can be produced by a production method including, for example, a mixing step that involves mixing precursor particles and Li together to obtain a mixture as well as a calcination step that involves calcining the mixture.

The precursor particle may be a particle that has a core portion, a gap portion outside the core portion, and an outer portion outside the gap portion and that is made of a Ni-containing transition metal composite hydroxide, for example.

The precursor particle can be produced by a production method that includes, for example, a crystallization step that involves generating a Taylor vortex reaction field and adding an aqueous solution containing a transition-metal-containing compound (hereinafter also called a raw material metal aqueous solution), an ammonium supplier, and an aqueous alkaline solution to the Taylor vortex reaction field to allow crystallization of a nickel-containing transition metal composite hydroxide (hereinafter also called a first metal hydroxide) to proceed.

The Ni-containing transition metal composite hydroxide may be a composite hydroxide further containing Mn, and it may be a nickel-cobalt-manganese composite hydroxide further containing Mn and Co. Preferably, the Ni-containing transition metal composite hydroxide is a nickel-cobalt-manganese composite hydroxide (hereinafter also called an NCM composite hydroxide).

The NCM composite hydroxide can be a compound represented by a formula (ii) below, for example:

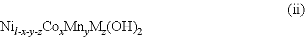

(in the formula (ii),
0≤x<0.5, 0≤y<0.5, 0≤z<0.05, and
M is one or more elements selected from the group consisting of Al, Ti, Zr, B, Mg, Fe, Cu, Zn, Sn, Na, K, Ba, Sr, Ca, W, Mo, Nb, Si, V, Cr, and Ge).

The composition of the first metal hydroxide can be determined by high-frequency inductively coupled plasma (ICP) atomic emission spectrometry, for example.

The transition-metal-containing compound in the raw material metal aqueous solution can be a sulfate, a nitrate, a carbonate, or the like of the transition metal, for example. The transition-metal-containing compound includes a Ni-containing compound. Examples of the Ni-containing compound include nickel sulfate (NiSO₄), nickel nitrate [Ni(NO₃)₂], nickel carbonate (NiCO₃), and the like.

When the first metal hydroxide is a composite hydroxide further containing Mn, the raw material metal aqueous solution can further contain a Mn-containing compound. Examples of the Mn-containing compound include manganese sulfate (MnSO₄), manganese nitrate [Mn(NO₃)₂], manganese carbonate (MnCO₃), and the like. When particle 10 having a gap portion is a transition metal composite oxide containing Li, Ni, Co, and Mn, the raw material metal aqueous solution can further contain a Mn-containing compound and a Co-containing compound. The Co-containing compound may be cobalt sulfate (CoSO₄), cobalt nitrate [Co(NO₃)₂], cobalt carbonate (CoCO₃), and/or the like, for example.

The raw material metal aqueous solution may further contain at least one element (hereinafter also called an additive element) selected from the group consisting of Al, Ti, Zr, B, Mg, Fe, Cu, Zn, Sn, Na, K, Ba, Sr, Ca, W, Mo, Nb, Si, V, Cr, and Ge, for example. The additive element may be added to the raw material metal aqueous solution, as the element itself or in the form of salt (for example, in the form of sulfate, nitrate, or carbonate).

The molar ratio of the transition-metal-containing compound in the raw material metal aqueous solution can be the molar ratio of the transition metal contained in the first metal hydroxide. The metal content of the raw material metal aqueous solution can be from 1.0 to 3.0 mol/L, for example.

When the raw material metal aqueous solution contains Mn, the molar ratio between Ni and Mn in the raw material metal aqueous solution may be Ni:Mn=[1−x]:[0<x<0.5], for example, and it may be [1−x]:[0.1<x<0.5] or [1−x]:[0.2<x<0.4].

When the raw material metal aqueous solution contains Mn and Co, the molar ratio between Ni, Mn, and Co in the raw material metal aqueous solution may be Ni:Mn:Co=[1−x−y]:[0<x<0.5]:[0<y<0.5], for example, and it may be [1−x−y]:[0.05<x<0.25]:[0.05<y<0.25] or [1−x−y]:[0.1<x<0.2]:[0.1<y<0.2].

When the raw material metal aqueous solution contains Mn, Co, and another element (an additive element), the molar ratio between Ni, Mn, Co, and the another element (an additive element) in the raw material metal aqueous solution may be Ni:Co:Mn:(Another element (Additive element))=[1−x−y−z]:[0<x<0.5]:[0<y<0.5]:[0<z<0.05], for example, and it may be [1−x−y−z]:[0.05<x<0.25]:[0.05<y<0.25]:[0.001<z<0.01] or [1−x−y−z]:[0.1<x<0.2]:[0.1<y<0.2]:[0.001<z<0.005].

As the ammonium supplier, an aqueous ammonia solution can be used, for example. The concentration of ammonia in the aqueous ammonia solution may be from 5 to 20 wt %, for example.

As the aqueous alkaline solution, an aqueous sodium hydroxide solution can be used, for example. The concentration of sodium hydroxide in the aqueous sodium hydroxide solution may be from 10 to 40 wt %, for example.

The Taylor vortex reaction field can be a fluid in which a Taylor vortex flow is generated. A Taylor vortex flow is a row of two doughnut-shaped vortices rotating in opposite directions, and it can be generated in the following manner, for example: fluid is added to fill the space between two concentric round tubes with the difference in radius smaller than their diameters; then one of the round tubes positioned inside (hereinafter also called an inner tube) is rotated while the round tube positioned outside (hereinafter also called an outer tube) remains still; and thereby a row of two vortices are generated between the outer tube and the inner tube, in the shape of rings along the circumference. Multiple rows of two vortices can be generated in the longitudinal direction of the two concentric round tubes (the direction vertical to the diameter).

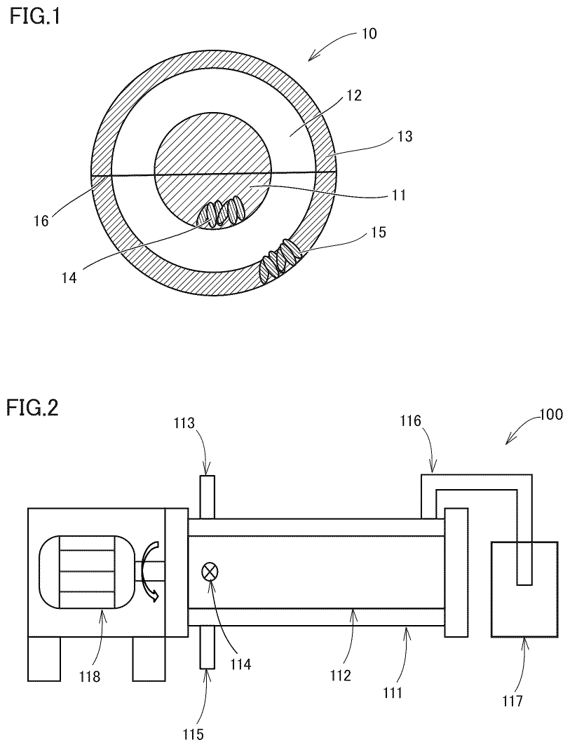

A description will be given of the reaction tank for generating a Taylor vortex reaction field, with reference to FIG. 2. A reaction tank 100 illustrated in FIG. 2 comprises an outer tube 111 and an inner tube 112. Outer tube 111 is fixed and held still. Inner tube 112 is rotatable by the action of a motor 118. Outer tube 111 comprises a first supply port 113 through which the raw material metal aqueous solution is supplied, a second supply port 114 through which the ammonium supplier is supplied, and a third supply port 115 through which the aqueous alkaline solution is supplied. Outer tube 111 further comprises a discharge port 116.

Inside the reaction tank 100, crystallization can be allowed to proceed in the following procedure, for example. Firstly, water is introduced through the first supply port 113 to fill the space between outer tube 111 and inner tube 112, and inner tube 112 is rotated to generate a Taylor vortex flow between outer tube 111 and inner tube 112, thereby generating a Taylor vortex reaction field. The rotational speed of inner tube 112 can be from 500 to 2000 rpm, for example.

An aqueous sodium hydroxide solution can be supplied through the third supply port 115 to the fluid to regulate the pH of the Taylor vortex reaction field at a liquid temperature of 25° C. to 12.5 or less. The pH at a liquid temperature of 25° C. can be controlled by regulating the flow rate of the aqueous sodium hydroxide solution with a pH controller, for example. The pH of the Taylor vortex reaction field at a liquid temperature of 25° C. may be 10.7 or more, for example. From the viewpoint of the circularity of particle 10 having a gap portion, the pH of the Taylor vortex reaction field at a liquid temperature of 25° C. is preferably from 11.0 to 12.5.

The crystallization step can include a first crystallization and a second crystallization, for example. The first crystallization can be started by supplying the raw material metal aqueous solution through the first supply port 113 and also supplying the ammonium supplier through the second supply port 114. The molar ratio between the raw material metal aqueous solution and the ammonium supplier supplied to the Taylor vortex reaction field can be 1:1. During the first crystallization, the oxygen concentration of the Taylor vortex reaction field can be maintained at 3.5 vol % or less. The oxygen concentration of the Taylor vortex reaction field may be maintained at 3.5 vol % or less by, for example, bubbling nitrogen gas into both the raw material metal aqueous solution and the ammonium supplier that are being supplied to the Taylor vortex reaction field. Hereinafter, the oxygen concentration of the Taylor vortex reaction field during a period of time from the start of crystallization to when the oxygen concentration of the Taylor vortex reaction field is changed as described below is also called a first oxygen concentration. The oxygen concentration of the Taylor vortex reaction field can be checked with a dissolved oxygen analyzer.

The duration of the first crystallization (hereinafter also called a first crystallization duration) can be set in such a manner that the ratio thereof to the total crystallization duration in the crystallization step (hereinafter also called a first crystallization ratio) falls within the range of 40% to 90%, for example. When the first crystallization ratio falls within the above-mentioned range, production of the precursor particles tends to be easier. When the first crystallization ratio is less than 40%, the core portion tends not to be formed. When the first crystallization ratio exceeds 90%, the outer portion tends not to be formed.

Then, the oxygen concentration of the Taylor vortex reaction field is changed to the range of 5 vol % to 65 vol %, and with this range being maintained, the second crystallization can be performed. The oxygen concentration of the Taylor vortex reaction field can be changed by changing the type of gas to bubble into the raw material metal aqueous solution and the ammonium supplier, for example. The type of the gas to use for maintaining the oxygen concentration of the Taylor vortex reaction field at the range of 5 vol % to 65 vol % during the second crystallization may be a mixed gas of oxygen and nitrogen, and/or the like, for example. While the oxygen concentration of the Taylor vortex reaction field is being changed, supply of the raw material metal aqueous solution and the ammonium supplier can be halted; and then, after the oxygen concentration of the Taylor vortex reaction field is changed to the range of 5 vol % to 65 vol %, the supply of the raw material metal aqueous solution and the ammonium supplier can be resumed for crystallization. The period of time during which the supply of the raw material metal aqueous solution and the ammonium supplier is halted is not included in the total crystallization duration. Hereinafter, the oxygen concentration of the Taylor vortex reaction field during the second crystallization is also called a second oxygen concentration. When the second oxygen concentration is less than 5 vol %, the outer portion tends not to be formed. When the second oxygen concentration exceeds 65 vol %, the circularity of the first particles tends not to be enhanced.

The duration of the second crystallization (hereinafter also called a second crystallization duration) may be set in such a manner that the ratio thereof to the total crystallization duration in the crystallization step (hereinafter also called a second crystallization ratio) falls within the range of 10% to 60%, for example. When the second crystallization ratio falls within the above-mentioned range, production of the first particles tends to be easier and the circularity tends to be enhanced. When the second crystallization ratio is less than 10%, the outer portion tends not to be formed. When the second crystallization ratio exceeds 60%, the circularity tends not to be enhanced. From the viewpoint of the production and the circularity of the precursor particles, the second crystallization ratio is preferably from 15% to 55%, more preferably from 20% to 50%. The second crystallization duration may be from 3 minutes to 30 minutes, for example. During the crystallization, the pH of the Taylor vortex reaction field at a liquid temperature of 25° C. is only required to be maintained at the pH adjusted before the start of crystallization. This makes it easier to produce the precursor particles. The pH of the Taylor vortex reaction field at a liquid temperature of 25° C. during crystallization is maintained at 12.5 or less, preferably at the range of 11.0 to 12.5.

In the crystallization step, after the second crystallization, another round of crystallization (hereinafter also called a third crystallization a) may be allowed to proceed with the oxygen concentration of the Taylor vortex reaction field changed from the range of 5 vol % to 65 vol % to 3.5 vol % or less, and another round of crystallization (hereinafter also called a third crystallization b) may be allowed to proceed with the oxygen concentration of the Taylor vortex reaction field changed from 3.5 vol % or less to the range of 5 vol % to 65 vol %. Each of the third crystallization a and the third crystallization b may be allowed to proceed at least once. When each of the third crystallization a and the third crystallization b is allowed to proceed at least once, precursor particles each having two or more layers of gap portions tend to be produced.

The first ratio and the second ratio can be controlled by regulating the below items in the crystallization step, for example: the pH, the oxygen concentration, the timing for switching the oxygen concentration, and the rotation of the inner tube.

The ratio of the diameter of core portion 11 to the particle size (diameter) of particle 10 having a gap portion can be controlled by regulating the below items in the crystallization step, for example: the pH, the oxygen concentration, the duration between the start of crystallization and the first switching of the oxygen concentration, and the rotational speed of the inner tube.

After the completion of the crystallization step, the solution containing the precursor particles can be discharged through the discharge port 116 and collected in a vessel 117. The collected solution containing the precursor particles can be filtrated, rinsed with water, and then dried, and thereby the precursor particles can be obtained.

In the mixing step, the precursor particles and Li can be mixed so that, for example, the ratio of the number of Li atoms to the total of metallic elements except Li in the positive electrode active material particles (the Li/Me ratio) falls within the range of 1.0 to 1.3, for example.

In the calcination step, the temperature for calcining the mixture may be, for example, from 700 to 1000° C., preferably from 700 to 850° C., more preferably from 710 to 850° C. The duration for calcining the mixture can be from 3 to 10 hours, for example. The calcination step can be carried out in an oxidizing atmosphere.

The second particle group contains a plurality of second particles. The content of the second particles in the second particle group, relative to the total amount of the second particle group which is regarded as 100 mass %, is from 70 to 100 mass %, for example, and it may be from 85 to 98 mass %, or may be from 90 to 95 mass %. It is possible that the second particle group solely contains a plurality of second particles.

The average particle size of the second particle group can be smaller than the average particle size of the first particle group. When the average particle size of the second particle group is smaller than the average particle size of the first particle group, breakage of the first particles due to pressing during production of a positive electrode active material layer is reduced and, in addition, packing properties of the positive electrode active material layer is enhanced, and as a result, a battery with excellent input-output properties and excellent cycle capacity retention tends to be obtained.

The average particle size of the second particle group may be from 2 to 20 μm, for example, and it is preferably from 2 to 7 μm. When the average particle size of the second particle group falls within this range, a battery with excellent cycle capacity retention tends to be obtained. The average particle size of the second particle group can be controlled by regulating production conditions such as precursor synthesis conditions (such as the reaction time and the pH) and calcination conditions (such as the calcination temperature and the calcination duration), for example.

The second particles include secondary particles each consisting of primary particles aggregated together (hereinafter also called second secondary particles). The second secondary particle is a lithium-(transition metal) composite oxide having a layered crystal structure (hereinafter also called a second composite oxide). The second composite oxide contains Li, Ni, Mn, Co, and M (where M is one or more metallic elements selected from the group consisting of Mg, Ca, Al, Ti, V, Cr, Fe, Cu, Zn, Zr, Nb, Mo, Ta, and W), and the molar ratio between Li, Ni, Mn, Co, and M is Li:Ni:Mn:Co:M=a:x:y:z:t (where a, x, y, z, and t satisfy 1.0≤a≤1.3, x+y+z=1, 0.25≤x≤0.9, 0<y≤0.6, 0<z≤0.6, and 0<t≤0.1). The expression that the second composite oxide contains Li, Ni, Mn, and Co means that it contains a lithium element, a nickel element, a manganese element, and a cobalt element. The composition of the second composite oxide can be determined by high-frequency inductively coupled plasma (ICP) atomic emission spectrometry (ICP-AES).

As for the second particle, the integrated intensity ratio (I₀₀₃/I₁₀₄) of diffraction peaks of the second secondary particle obtained by an X-ray diffraction method (hereinafter also called an XRD method) is from 1.05 to 1.19, and the crystallite size L₀₀₃ of the second secondary particle is 1000 Å or more. When the integrated intensity ratio (I₀₀₃/I₁₀₄) and the crystallite size Loos of the second secondary particle fall within these ranges, cycle capacity retention tends to be enhanced.

The second secondary particle is an aggregated particle consisting of primary particles. The number of primary particles aggregated together to form each second secondary particle is preferably 50 or more, and it may be 100 or more, or may be 1000 or more; and usually, it is 5×10⁶ or less, and it may be 5×10⁵ or less. The above-mentioned number to form each second secondary particle can be controlled by regulating production conditions for producing the second secondary particles, such as calcination conditions (such as the calcination temperature, the number of calcination operations to perform, and the calcination duration). The number of primary particles aggregated together to form each second secondary particle can be checked in an SEM image captured with a scanning electron microscope (hereinafter also called “an SEM”), for example. The second secondary particle can be an aggregated particle having a solid structure with no pores inside.

The second secondary particle is the second composite oxide, and the presence of a layered crystal structure in the second composite oxide can be checked by X-ray diffraction measurement and/or the like, for example. The layered crystal structure of the second composite oxide may be a hexagonal structure (of lamellar rock salt type), a monoclinic structure, or the like. When the second composite oxide has a layered crystal structure, lithium ions can be inserted into it and deserted out of it in a smooth fashion.

The metallic element M contained in the second composite oxide is simply required to include one or more types among the above-mentioned metallic elements, and preferably, it includes at least W (tungsten). When the metallic element M includes W, a composite oxide having an integrated intensity ratio (I₀₀₃/I₁₀₄) and a crystallite size L₀₀₃ falling within the above-mentioned ranges tends to be obtained.

The molar ratio of Li is 1.0≤a≤1.3, and it may be 1.0≤a≤1.25, or may be 1.01≤a≤1.2, or may be 1.03≤a≤1.15, or may be 1.04≤a≤1.1. The molar ratio of Ni is 0.25≤x≤0.9, and it may be 0.3≤x≤0.9, or may be 0.4≤x≤0.88, or may be 0.5≤x≤0.85. The molar ratio of Mn is 0<y≤0.6, and it may be 0.05≤y≤0.5, or may be 0.08≤y≤0.3, or may be 0.10≤y≤0.2. The molar ratio of Co is 0<z≤0.6, and it may be 0<z≤0.5, or may be 0.01≤z≤0.3, or may be 0.02≤z≤0.1. The molar ratio of M is 0<t≤0.1, and it may be 0<t≤0.08, or may be 0.001≤t≤0.05, or may be 0.002≤t≤0.01. When the second composite oxide contains two or more types of metallic elements M, the molar ratio of M refers to the total amount of these two or more types of metallic elements.

The integrated intensity ratio (I₀₀₃/I₁₀₄) of diffraction peaks of the second secondary particle is from 1.05 to 1.19, and it may be from 1.06 to 1.18, or may be from 1.08 to 1.17, or may be from 1.10 to 1.15. Preferably, the integrated intensity ratio (I₀₀₃/I₁₀₄) is from 1.05 to 1.16, more preferably from 1.06 to 1.15. When the integrated intensity ratio (I₀₀₃/I₁₀₄) exceeds the above-mentioned range, crystal growth of the primary particles during production of the secondary particles is facilitated and thereby breakage of the secondary particles tends to occur, which tends to degrade cycle capacity retention. The second secondary particle has an integrated intensity ratio (L₀₀₃/I₁₀₄) falling within the above-mentioned range, and therefore tends not to break. As a result, when the second secondary particles are used, a battery with excellent cycle retention tends to be obtained.

The integrated intensities I₀₀₃ and I₁₀₄ of diffraction peaks of the second secondary particle obtained by an XRD method are the integrated intensities of the diffraction peaks at a (003) plane and a (104) plane of the second secondary particle measured by an XRD method, respectively, and can be measured by a method described below in the Examples section. The integrated intensity ratio (I₀₀₃/I₁₀₄) of the second secondary particle can be regulated by changing production conditions for producing the second secondary particles, such as, for example, the amount of lithium to be added (the blending ratio), the raw material composition, and the calcination conditions (such as the calcination temperature, the number of calcination operations to perform, and the calcination duration).

The crystallite size L₀₀₃ of the second secondary particle is 1000 Å or more, and it may be 1010 Å or more, or may be 1020 Å or more, or may be from 1000 to 3000 Å, or may be from 1010 to 2500 Å, or may be from 1020 to 2000 Å, or may be from 1020 to 1500 Å. When the integrated intensity ratio (I₀₀₃/I₁₀₄) falls within the above-mentioned range, Li-site occupancy in the transition metal layer of the secondary particle tends to be high and thereby discharged capacity of the secondary battery tends to be degraded. On the other hand, when the crystallite size L₀₀₃ of the second secondary particle falls within the above-mentioned range, Li-site occupancy can be made low and thereby degradation of discharged capacity of the battery can be eased.

The crystallite size L₀₀₃ of the second secondary particle can be calculated from a half width of the diffraction peak at a (003) plane of the secondary particle measured by an XRD method, and can be calculated by a method described below in the Examples section. The crystallite size L₀₀₃ of the second secondary particle can be regulated by changing production conditions for producing the second secondary particles, such as, for example, the amount of lithium to be added (the blending ratio), the raw material composition, and the calcination conditions (such as the calcination temperature, the number of calcination operations to perform, and the calcination duration).

The second secondary particles can be obtained by, for example, mixing together a compound containing Ni, Mn, and Co (hereinafter also called “a NiMnCo-containing precursor”), a lithium compound, and, as needed, an M-containing compound that contains a metallic element M to obtain a mixture and calcining the mixture. Alternatively, the second secondary particles may be obtained by mixing together a Ni-containing compound that contains Ni, a Mn-containing compound that contains Mn, a Co-containing compound that contains Co, a lithium compound, and an M-containing compound that contains a metallic element M to obtain a mixture and calcining the mixture. Each of the Ni-containing compound, the Mn-containing compound, and the Co-containing compound may contain a metallic element M.

The NiMnCo precursor may be, for example, a composite oxide or a composite hydroxide that contains Ni, Mn, and Co. Examples of the lithium compound include lithium hydroxide, lithium carbonate, and the like. Examples of the M-containing compound include an ammonium compound that contains a metallic element M, and the like.

The mass ratio between the first particle group and the second particle group in the positive electrode active material may be (First particle group):(Second particle group)=8:2 to 5:5, for example. With this mass ratio, a battery with excellent input-output properties and excellent cycle capacity retention tends to be obtained. The positive electrode active material can be obtained by mixing the first particle group and the second particle group together.

In addition to the first particles and the second particles, the positive electrode active material may also contain positive electrode active material particles of a different type from the first particles and the second particles. The positive electrode active material particles of a different type from the first particles and the second particles that may be contained in the positive electrode active material may be single particles, or may be secondary particles other than the first particles and the second particles (hereinafter also called additional secondary particles). The single particles may be a lithium-(transition metal) composite oxide having a layered crystal structure, and the composition thereof may be within the range of the composition described above for the first particle group and the second particle group or may be outside the range of the above-described composition. The additional secondary particles may be secondary particles having a composition outside the range of the composition described above for the second secondary particles, or secondary particles having an integrated intensity ratio (I₀₀₃/I₁₀₄) outside the above-described range, or secondary particles having a crystallite size L₀₀₃ outside the above-described range. The additional secondary particles may have a solid structure without pores, or may have a structure with pores.

### Positive Electrode Plate

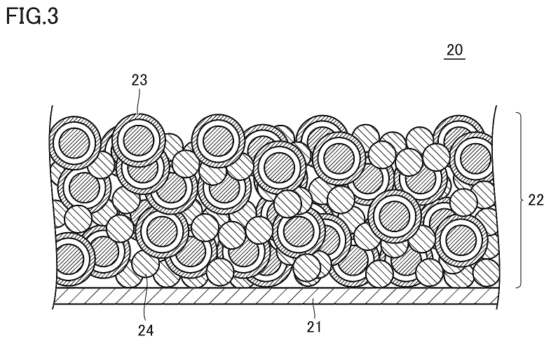

A positive electrode plate according to the present disclosure will be described referring to FIG. 3. FIG. 3 is a schematic cross-sectional view of the positive electrode plate in a thickness direction (a stacking direction). A positive electrode plate 20 has a positive electrode current collector 21, and a positive electrode active material layer 22 containing the above-described positive electrode active material, and positive electrode active material layer 22 is disposed on positive electrode current collector 21.

The positive electrode active material contains first particles 23 and second particles 24 described above. Positive electrode active material layer 22 is formed on one side or both sides of positive electrode current collector 21. Positive electrode current collector 21 is a metal foil sheet that is made by using an Al material such as Al and Al alloy, for example, and the metal foil sheet is not particularly limited as long as it is stable at the electric potential range of positive electrode plate 20.

In addition to the positive electrode active material, positive electrode active material layer 22 may include a binder, a conductive material, and the like. The binder may be a known material, such as, for example, a fluororesin such as polyvinylidene difluoride (PVdF) and polytetrafluoroethylene (PTFE) and/or a cellulose-based resin such as carboxymethylcellulose (CMC). The conductive material may be a carbon material, for example. The carbon material may be one or more selected from the group consisting of fibrous carbon, carbon black, coke, and activated carbon, for example. The fibrous carbon may be carbon nanotubes (CNTs), for example.

Positive electrode active material layer 22 can be formed by, for example, applying a positive electrode composite material slurry to positive electrode current collector 21, drying, and compression. The positive electrode composite material slurry can be prepared by adding a solvent such as N-methyl-2-pyrrolidone (NMP) to the active-material-layer-forming materials such as the above-described positive electrode active material, the binder, and the conductive material, and mixing and kneading the resultant.

Positive electrode active material layer 22 may have a thickness from 10 to 200 μm, for example. The positive electrode active material layer may have a high density. The positive electrode active material layer may have a density of 3.5 g/cm³ or more, for example, and it may have a density of 4.0 g/cm³ or less, for example.

### Non-Aqueous Electrolyte Secondary Battery

A battery according to the present disclosure has the positive electrode plate described above. As a result, it tends to have excellent input-output properties and excellent cycle capacity retention.

Usually, the battery includes an electrode assembly that includes the positive electrode plate, and a non-aqueous electrolyte solution. The battery may have a battery case for accommodating the electrode assembly and the non-aqueous electrolyte solution. The battery case can include an exterior package having an opening, and a sealing plate for sealing the opening. Each of the exterior package and the sealing plate can be formed with a metal such as, for example, Al, Al alloy, iron, or iron alloy, and it can be formed by using an Al-laminated film, for example. Between the electrode assembly and the exterior package, a resin sheet may be provided as an electrode holder.

The electrode assembly may include the positive electrode plate, a negative electrode plate, and a separator. In the electrode assembly, the active material layer of the positive electrode plate faces a negative electrode active material layer of the negative electrode plate, with the separator interposed therebetween. The electrode assembly may be a stack-type one that is formed by stacking the positive electrode plate, the negative electrode plate, and the separator, or may be a wound-type one that is formed by stacking the positive electrode plate, the negative electrode plate, and the separator and winding the resulting stack.

Usually, the negative electrode plate has a negative electrode current collector, as well as a negative electrode active material layer formed on one side or both sides of the negative electrode current collector. The negative electrode current collector is a metal foil sheet that is made by using a copper material such as copper and copper alloy, for example. The negative electrode active material layer includes a negative electrode active material, and it may further include a conductive material, a binder, and the like.

The negative electrode active material may be a known material, and examples thereof include carbon-based active material particles such as graphite, metal-based active material particles that include an element selected from the group consisting of Si, Sn, Sb, Bi, Ti, and Ge, and the like. Examples of the conductive material include those mentioned above. Examples of the binder include cellulose-based resins such as CMC, methylcellulose (MC), and hydroxypropylcellulose; polyacrylic acid; styrene-butadiene rubber (SBR); and the like. CMC may also be used as a thickener.

The separator has a monolayered or multilayered base material, and on at least one side of the base material, it may have a functional layer. The base material may be a porous sheet such as a film and/or a nonwoven fabric, which is made of a resin such as polyolefin (such as polyethylene and polypropylene), polyester, cellulose, polyamide, and/or the like. The functional layer may be an adhesive layer and/or a heat-resistant layer, for example. The adhesive layer can be formed with an adhesive agent, for example. The heat-resistant layer can include a filler and a binder, for example.

The non-aqueous electrolyte solution is preferably obtained by adding an electrolyte to a non-aqueous solvent such as an organic solvent. Examples of the electrolyte include one or more from LiPF₆, LiBF₄, LiClO₄, LiFSO₃, LiBOB, and the like. Examples of the non-aqueous solvent include one or more from ethylene carbonate (EC), ethyl methyl carbonate (EMC), dimethyl carbonate (DMC), propylene carbonate (PC), butylene carbonate (BC), diethyl carbonate (DEC), and the like. The non-aqueous electrolyte solution may further include an additive such as vinylene carbonate (VC), vinylethylene carbonate (VEC), and/or fluoroethylene carbonate.

In the following, the present invention will be described in further detail by way of Examples.

### Examples

### Measurement of Average Particle Size

In accordance with JIS Z 8825:2022 Particle size analysis-Laser diffraction methods, the average particle size (D50) of first particles A and B, second particles A and B, particles C, and particles D used in Examples and Comparative Examples was measured. The laser-diffraction particle size distribution measurement apparatus used here was “MT3000II” manufactured by Microtrac. In wet dispersion, isopropyl alcohol (IPA) was used as the solvent.

### Measurement of BET Specific Surface Area

With a commercially available flow-type gas adsorption specific surface area measurement apparatus, the BET specific surface area of first particles A and B, second particles A and B, particles C, and particles D used in Examples and Comparative Examples was measured.

### Measurement of Circularity

With a commercially available particle shape image analyzer, the circularity of first particles A and B, particles C, and particles D used in Examples and Comparative Examples was measured.

### Measurement of Primary Particle Size, First Ratio, and Second Ratio

By ion milling work, cross sections of first particles A and B, particles C, and particles D used in Examples and Comparative Examples were exposed. The cross section was examined with a commercially available scanning electron microscope (SEM), and thereby an SEM image was captured. As for the primary particle size, 50 or more primary particles were selected and the average particle size was calculated with the use of image analysis software. Also in the image, with the use of image analysis software, the region of the gap portion and the region of the outer portion were discriminated, and from the scale ratio, the first ratio (Gap portion width)/(Particle size) and the second ratio (Outer portion thickness)/(Particle size) were calculated.

### Measurement of Integrated Intensity Ratio (I₀₀₃/I₁₀₄) and Crystallite Size L₀₀₃

Second particles A and B, particles C, and particles D used in Examples and Comparative Examples were pulverized in a mortar made of agate until the average particle size (D50) reached 43 μm or less, followed by X-ray diffraction measurement with an X-ray diffraction apparatus (“SmartLab” manufactured by Rigaku). The XRD profile obtained by the X-ray diffraction measurement indicated that the lithium-(transition metal) composite oxide had a layered crystal structure.

From the integrated intensity ratio of the diffraction peaks at a (003) plane and a (104) plane in the XRD profile, the integrated intensity ratio (I₀₀₃/I₁₀₄) was calculated.

The value of the half width of the intensity I₀₀₃ of the diffraction peak at a (003) plane in the XRD profile was used as the breadth B of the diffraction peak in the Scherrer equation below, to calculate the crystallite size L₀₀₃ at a (003) plane.

$${L}_{003} = K λ / B cos θ$$

(In the equation, K is the Scherrer constant; λ is the wavelength [nm] of the X-ray; B is the breadth [rad] of the diffraction peak; and θ is the Bragg angle [rad].)

### Preparation of Battery

A mixture of graphite and SiO was prepared as a negative electrode active material, and styrene-butadiene rubber (SBR) and carboxymethylcellulose (CMC) were prepared as binders. The negative electrode active material, SBR, and CMC in a mass ratio of (Negative electrode active material):SBR:CMC=100:1:1 were mixed with water to prepare a negative electrode slurry. The negative electrode slurry was applied to a copper foil sheet as a negative electrode current-collecting foil sheet, dried and compressed, followed by cutting the resultant into a certain size, and thereby a negative electrode plate was obtained.

A separator having a three-layer structure (polypropylene/polyethylene/polypropylene) was prepared.

The positive electrode plate prepared in Examples and Comparative Examples and the negative electrode plate were stacked together with the separator interposed therebetween, and thereby an electrode assembly was obtained. At the ends of the resulting electrode assembly, a positive electrode tab which was a portion of the aluminum foil sheet (the positive electrode current-collecting foil sheet) at which the positive electrode active material layer was not formed, and a negative electrode tab which was a portion of the copper foil sheet (the negative electrode current-collecting foil sheet) at which the negative electrode active material layer was not formed were exposed, respectively. The positive electrode tab was welded to an external positive electrode current collector and the negative electrode tab was welded to an external negative electrode current collector, and then the resultant was inserted into an exterior package made of an aluminum laminated film, followed by fusing the film in such a manner to form a liquid inlet. Through the liquid inlet, non-aqueous electrolyte solution was injected, followed by sealing the liquid inlet to prepare a battery.

### Evaluation of Input-Output Properties

The battery thus prepared was charged up to an SOC of 50%. After one hour of resting, another round of resting was carried out in an environment at a temperature of −10° C. for 6 hours. Subsequently, at a current of 5 C, discharging was carried out for 10 seconds. The resistance was determined by the below equation, with V0 representing the OCV voltage immediately before discharging and V1 representing the voltage after 10 seconds of discharging.

$$Resistance ( Ω ) = ( V 0 - V 1 ) / 5 C ( value of current ) .$$

It is considered that the lower the resistance is, the more excellent the input-output properties are.

### Evaluation of Cycle Capacity Retention

In an environment at a temperature of 25° C., the battery prepared in the above manner was subjected to 300 cycles of charging and discharging, where one cycle consisted of charging and discharging at 0.5 C within a voltage range between 4.2 V and 3.0 V. In an environment at a temperature of 25° C., within a voltage range between 4.2 V and 3.0 V, charging and discharging were carried out at 0.1 C, and the capacity during discharging was defined as post-cycle battery capacity. The cycle capacity retention was calculated by the following equation.

$$Cycle capacity retention = ( Post - cycle battery capacity ) / ( Initial battery capacity )$$

It is considered that the higher the cycle capacity retention is, the more excellent the cycle capacity retention is.

### Example 1

### Preparation of Positive Electrode Plate

As first particles, first particles A were prepared. By SEM examination, it was identified that each first particle A was a secondary particle consisting of 50 or more primary particles aggregated together and that it had a core portion, a gap portion outside the core portion, and an outer portion outside the gap portion. The composition, the average particle size (D50), the BET specific surface area, the primary particle size, the circularity, the first ratio, and the second ratio of the first particles A are given in Table 1.

As second particles, second particles A were prepared. By SEM examination, it was identified that each second particle A was a secondary particle consisting of 50 or more primary particles aggregated together and that it had a solid structure with no gap portion inside the particle. The composition, the average particle size (D50), the BET specific surface area, the integrated intensity ratio (I₀₀₃/I₁₀₄), and the crystallite size L₀₀₃ of the second particles A are given in Table 2.

100 parts by mass of a positive electrode active material mixture obtained by mixing the first particles A and the second particles A in a weight ratio of 8:2, 1 part by mass of graphite as a conductive material, and 1 part by mass of polyvinylidene difluoride powder as a binder were mixed together, and thereto, a proper amount of N-methyl-2-pyrrolidone (NMP) was further added, to prepare a positive electrode composite material slurry.

The resulting positive electrode composite material slurry was applied to both sides of a positive electrode current collector made of an aluminum foil sheet, and dried. This was followed by rolling the coating with a roller, and thereby, a positive electrode plate was prepared, which had the positive electrode active material layer formed on both sides of the positive electrode current collector. The density of the positive electrode active material layer was 3.55 g/m². Results are given in Table 4.

### Example 2

Instead of the first particles A and the second particles A in Example 1, first particles B and second particles B were used, and except this, the same manner as in Example 1 was adopted to prepare a positive electrode plate. By SEM examination, it was identified that each first particle B was a secondary particle consisting of 50 or more primary particles aggregated together and that it had a core portion, a gap portion outside the core portion, and an outer portion outside the gap portion. The composition, the average particle size (D50), the BET specific surface area, the primary particle size, the circularity, the first ratio, and the second ratio of the first particles B are given in Table 1. By SEM examination, it was identified that each second particle B was a secondary particle consisting of 50 or more primary particles aggregated together and that it had a solid structure with no gap portion inside the particle. The composition, the average particle size (D50), the BET specific surface area, the integrated intensity ratio (I₀₀₃/I₁₀₄), and the crystallite size L₀₀₃ of the second particles B are given in Table 2. Results are given in Table 4.

### Examples 3 to 5

Instead of the mixing ratio (8:2) between the first particles A and the second particles A in Example 1, the mixing ratio between the first particles A and the second particles A specified in Table 4 was adopted, and except this, the same manner as in Example 1 was adopted to prepare a positive electrode plate. Results are given in Table 4.

### Comparative Example 1

Instead of the first particles A and the second particles A in Example 1, particles C and particles D were used, and except this, the same manner as in Example 1 was adopted to prepare a positive electrode plate. By SEM examination, it was identified that each particle C was a secondary particle consisting of 50 or more primary particles aggregated together and that it had a solid structure with no gap portion inside the particle. The composition, the average particle size (D50), the BET specific surface area, the primary particle size, the circularity, the integrated intensity ratio (I₀₀₃/I₁₀₄), and the crystallite size L₀₀₃ of the particles C are given in Table 3. By SEM examination, it was identified that each particle D was a single particle (one single particle or a secondary particle consisting of 2 to 10 primary particles). The composition, the average particle size (D50), the BET specific surface area, the circularity, the integrated intensity ratio (I₀₀₃/I₁₀₄), and the crystallite size Loos of the particles D are given in Table 3. Results are given in Table 4.

### Comparative Example 2

Instead of the first particles A and the second particles A in Example 1, only the first particles A were used, and except this, the same manner as in Example 1 was adopted to prepare a positive electrode plate. Results are given in Table 4.

### Comparative Example 3

Instead of the first particles A and the second particles A in Example 1, only the second particles A were used, and except this, the same manner as in Example 1 was adopted to prepare a positive electrode plate. Results are given in Table 4.

### Comparative Example 4

100 parts by mass of first particles A as a positive electrode active material, 1 part by mass of graphite as a conductive material, and 1 part by mass of polyvinylidene difluoride powder as a binder were mixed together, and thereto, a proper amount of N-methyl-2-pyrrolidone (NMP) was further added, to prepare a first positive electrode composite material slurry. 100 parts by mass of second particles A as a positive electrode active material, 1 part by mass of graphite as a conductive material, and 1 part by mass of polyvinylidene difluoride powder as a binder were mixed together, and thereto, a proper amount of N-methyl-2-pyrrolidone (NMP) was further added, to prepare a second positive electrode composite material slurry.

The resulting second positive electrode composite material slurry was applied to both sides of a positive electrode current collector made of an aluminum foil sheet, and dried. Then, to the coating made of the second positive electrode composite material slurry, the first positive electrode composite material slurry was applied, and dried. The ratio of application thickness was (First positive electrode composite material slurry)/(Second positive electrode composite material slurry)=8:2. Subsequently, the coating was rolled with a roller. Thereby, a positive electrode plate was prepared, in which a positive electrode active material layer was formed on each side of the positive electrode current collector, and in which the positive electrode active material layer had a second layer containing the second particles A positioned on the positive electrode current collector side as well as a first layer containing the first particles A positioned on the opposite side to the second layer (namely, on the opposite side to the positive electrode current collector). By SEM examination of a cross section of the positive electrode plate thus prepared, it was identified that the thickness ratio between the first layer (the upper layer) and the second layer (the lower layer) was (First layer):(Second layer)=8:2. Results are given in Table 4.

TABLE 1

| | | | BET | | | | |
|---|---|---|---|---|---|---|---|
| | | Average | Specific | Primary | | | |
| | | particle | surface | particle | | First | Second |
| | | size | area | size | | ratio | ratio |
| | Composition | (μm) | (m²/g) | (μm) | Circularity | (%) | (%) |
| First | Li_{1.09}Ni_{0.83}Co_{0.05}Mn_{0.12}O₂ | 12.4 | 1.2 | 0.7 | 0.94 | 42 | 33 |
| particles | | | | | | | |
| A | | | | | | | |
| First | Li_{1.09}Ni_{0.83}Co_{0.05}Mn_{0.12}O₂ | 4.1 | 1.9 | 0.5 | 0.93 | 50 | 25 |
| particles | | | | | | | |
| B | | | | | | | |

TABLE 2

| | | | BET | | |
|---|---|---|---|---|---|
| | | Average | Specific | Integrated | |
| | | particle | surface | intensity | Crystallite |
| | | size | area | ratio | size L₀₀₃ |
| | Composition | (μm) | (m²/g) | (I₀₀₃/I₀₀₄) | (nm) |
| Second | Li_{1.06}Ni_{0.83}Co_{0.05}Mn_{0.12}W_{0.0005}O₂ | 4.3 | 0.95 | 1.2 | 1115 |
| particles | | | | | |
| A | | | | | |
| Second | Li_{1.06}Ni_{0.83}Co_{0.05}Mn_{0.12}W_{0.0005}O₂ | 12.1 | 0.82 | 1.25 | 1646 |
| particles | | | | | |
| B | | | | | |

TABLE 3

| | | Average | BET | Primary | | Integrated | |
|---|---|---|---|---|---|---|---|
| | | particle | Specific | particle | | intensity | Crystallite |
| | | size | surface area | size | | ratio | size L₀₀₃ |
| | Composition | (μm) | (m²/g) | (μm) | Circularity | (I₀₀₃/I₀₀₄) | (nm) |
| Particles | Li_{1.06}Ni_{0.83}Co_{0.05}Mn_{0.12}O₂ | 12.4 | 0.83 | 0.7 | 0.94 | 1.2 | 1115 |
| C | | | | | | | |
| Particles | Li_{1.06}Ni_{0.83}Co_{0.05}Mn_{0.12}O₂ | 4.3 | 0.89 | — | 0.87 | 1.25 | 1646 |
| D | | | | | | | |

TABLE 4

| | | Mixing ratio | Input- | Cycle |
|---|---|---|---|---|
| | | (First | output | capacity |
| | Type of particles | particles:Second | properties | retention |
| | used | particles) | (Ω) | (%) |
| Ex. 1 | First particles A, | 8:2 | 470.9 | 95.2 |
| | Second particles A | | | |
| Ex. 2 | First particles B, | 2:8 | 495.7 | 94.0 |
| | Second particles B | | | |
| Ex. 3 | First particles A, | 9:1 | 457.2 | 95 |
| | Second particles A | | | |
| Ex. 4 | First particles A, | 5:5 | 475.7 | 95.1 |
| | Second particles A | | | |
| Ex. 5 | First particles A, | 4:6 | 480.5 | 95.1 |
| | Second particles A | | | |
| Comp. | Particles C, | 8:2 (Particles | 523.2 | 95.1 |
| Ex. 1 | Particles D | C:Particles D) | | |
| Comp. | First particles A | — | 448.5 | 93.4 |
| Ex. 2 | | | | |
| Comp | Second particles A | — | 506.3 | 95.1 |
| Ex. 3 | | | | |
| Comp. | First layer: | — | 465.7 | 94.2 |
| Ex. 4 | First particles A, | | | |
| | Second layer: | | | |
| | Second particles A | | | |

In Examples 1 and 3 to 5, first particles having excellent input-output properties were mixed together with second particles having excellent Li diffusivity in solid phase and less likely to break, and as a result, excellent input-output properties and excellent cycle capacity retention were obtained. In contrast, in Comparative Example 1, single particles which were less likely to break were used as second particles, and thereby, excellent cycle capacity retention was obtained; however, due to the use of aggregated particles having a solid structure as well as single particles, Li diffusivity in solid phase was poor and input-output properties were not obtained. In Comparative Example 2 where particles having a gap portion were solely used, excellent input-output properties were obtained, but due to the influence of particle breakage during rolling in the preparation of the positive electrode plate, cycle capacity retention was poor as compared to Example 1. In Comparative Example 3, cycle capacity retention was as excellent as in Comparative Example 1, but input-output properties were poor as compared to Example 1.

In Example 2, the mass ratio of the second particles to the first particles was higher than in Examples 1 and 3 to 5, and as a result, although input-output properties were poor as compared to Examples 1 and 3 to 5, excellent input-output properties and excellent cycle capacity retention were obtained as compared to Comparative Example 1 where first particles and second particles were not used and also as compared to Comparative Example 2 and Comparative Example 3 where only one type of particles were used.

In Comparative Example 4, due to the first particles contained in the first layer (the upper layer), excellent input-output properties were obtained; however, the first particles with relatively large reaction area were contained in the first layer (the upper layer) at which reactions tend to be concentrated, and as a result, reactions were facilitated to lead to more degradation, as a result of which excellent cycle capacity retention was not obtained.

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A positive electrode active material comprising:
a first particle group; and
a second particle group, wherein
the first particle group contains a plurality of first particles,
the second particle group contains a plurality of second particles,
the first particles include particles each having a gap portion,
the second particles include secondary particles each consisting of primary particles aggregated together,
an integrated intensity ratio (I₀₀₃/I₁₀₄) of diffraction peaks of the secondary particle obtained by an X-ray diffraction method is from 1.05 to 1.19, and
the secondary particle has a crystallite size L₀₀₃ of 1000 Å or more.

2. The positive electrode active material according to claim 1, wherein a mass ratio between the first particle group and the second particle group in the positive electrode active material is (First particle group):(Second particle group)=8:2 to 5:5.

3. The positive electrode active material according to claim 1, wherein the first particle has a circularity of 0.92 or more.

4. The positive electrode active material according to claim 1, wherein the first particle has a core portion, the gap portion outside the core portion, and an outer portion outside the gap portion.

5. The positive electrode active material according to claim 1, wherein the first particle group has an average particle size of 8 to 20 μm.

6. The positive electrode active material according to claim 1, wherein the second particle group has an average particle size of 2 to 7 μm.

7. The positive electrode active material according to claim 1, wherein
the second particle contains a lithium-(transition metal) composite oxide having a layered crystal structure, and
the lithium-(transition metal) composite oxide contains Li, Ni, Mn, Co, and M, where
M is one or more metallic elements selected from the group consisting of Mg, Ca, Al, Ti, V, Cr, Fe, Cu, Zn, Zr, Nb, Mo, Ta, and W,
a molar ratio between Li, Ni, Mn, Co, and M is Li:Ni:Mn:Co:M=a:x:y:z:t, and
a, x, y, z, and t satisfy 1.0≤a≤1.3, x+y+z=1, 0.25≤x≤0.9, 0<y≤0.6, 0<z≤0.6, and 0<t≤0.1.

8. A positive electrode plate comprising the positive electrode active material according to claim 1.

9. A non-aqueous electrolyte secondary battery comprising the positive electrode plate according to claim 8.
